(19) United States
(12) Patent Application Publication
(10) Pub. No.: US 2026/0003740 A1
(43) Pub. Date: Jan. 1, 2026

(54) ACCELERATOR PRE-PROCESSOR FOR BACKUP CLIENTS

(71) Applicant: University of Kentucky Research Foundation, Lexington, KY (US)

(72) Inventor: Ray Lloyd HYATT, JR., Lexington, KY (US)

(21) Appl. No.: 19/249,380

(22) Filed: Jun. 25, 2025

Related U.S. Application Data
(60) Provisional application No. 63/665,036, filed on Jun. 27, 2024.

(51) Int. Cl. G06F 11/14

(52) U.S. Cl. CPC G06F 11/1464; G06F 2201/80

(57) ABSTRACT

Certain aspects of the disclosure provide a method for performing backup operations in a computing environment. The method may include: performing a depth-restricted find operation on a file system to identify directories for backup; generating a list of potential backup jobs by analyzing the identified directories and determining a backup type for each directory; sorting the list of potential backup jobs based on at least one of criticality, file size, or historical backup performance; randomizing the sorted list of backup jobs while maintaining critical job ordering requirements; determining resource requirements for each backup job, including memory usage, CPU utilization, and network bandwidth consumption; creating a backup schedule by matching backup jobs to available system resources; and executing the backup jobs according to the backup schedule, while dynamically adjusting the schedule based on real-time resource availability.

### CROSS REFERENCE

This application claims the benefit of U.S. Provisional Application Ser. No. 63/665,036 filed Jun. 24, 2024, which is incorporated by reference in its entirety.

### BACKGROUND

### Field

Aspects of the present disclosure relate to data backup and protection systems.

### Description of Related Art

Data backup and protection systems are important components of modern computing environments, especially in large-scale operations such as research institutions and universities. These systems may be responsible for safeguarding vast amounts of valuable data generated through time-consuming and resource-intensive processes. As the volume of data continues to grow exponentially, traditional backup methods face increasing challenges in efficiently handling and protecting this information.

High-performance computing (HPC) environments, such as supercomputers used in academic and research settings, present unique challenges for data backup systems. These environments often contain enormous datasets spread across deeply nested directory structures with millions of files. The sheer scale and complexity of these file systems can overwhelm conventional backup solutions, leading to extended backup times that may span days or even weeks for a single backup pass.

As one example, one significant bottleneck in backing up large-scale file systems is the process of identifying which files need to be backed up. Traditional backup clients must scan through the entire file system, examining each file and directory to determine if changes have occurred since the last backup. This scanning process can be extremely time-consuming, especially when dealing with deeply nested directory structures containing vast numbers of small files, which is common in bioinformatics and other data-intensive research fields.

Another challenge in backing up HPC environments may be the limitation of network bandwidth between the backup client and the backup server. Conventional backup systems typically use a single network path to transfer data, which can become a bottleneck when dealing with massive datasets. This network limitation can further extend backup times and potentially impact the performance of other network-dependent operations within the HPC environment.

Memory constraints on backup client systems may also pose difficulties when dealing with large-scale backups. Metadata associated with extensive file systems can be substantial, and some backup solutions attempt to load this metadata into memory for faster processing. However, in extremely large environments, the size of this metadata can exceed the available memory on the backup client, causing the backup process to fail or perform poorly.

### SUMMARY

Certain aspects provide a method for performing backup operations in a computing environment, comprising: performing a depth-restricted find operation on a file system to identify directories for backup; generating a list of potential backup jobs by analyzing the identified directories and determining a backup type for each directory; sorting the list of potential backup jobs based on at least one of criticality, file size, or historical backup performance; randomizing the sorted list of backup jobs while maintaining backup job ordering requirements; determining resource requirements for each backup job, including memory usage, CPU utilization, and network bandwidth consumption; creating a backup schedule by matching backup jobs to available system resources; and executing the backup jobs according to the backup schedule, while dynamically adjusting the schedule based on real-time resource availability.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a system for creating one or more backup jobs, in accordance with aspects of the present disclosure.

FIG. 2 depicts an example backup system, illustrating various components involved in the backup process, in accordance with aspects of the present disclosure.

FIG. 3 depicts a flowchart of operations for backup operations, in accordance with aspects of the present disclosure.

FIG. 4 depicts a plurality of backup jobs and an example backup job, illustrating the flow of operations between a backup client and server, in accordance with aspects of the present disclosure.

FIG. 5 depicts an example file system and file tree or directory structure, illustrating how the backup system interacts with the file system, in accordance with aspects of the present disclosure.

FIG. 6 depicts a pseudocode representation of an algorithm for intelligent backup job creation, in accordance with aspects of the present disclosure.

FIG. 7 depicts a pseudocode representation of an algorithm for dynamic job dispatching and execution in a backup system, in accordance with aspects of the present disclosure.

FIG. 8 depicts an example method for performing backup operations in a computing environment, in accordance with aspects of the present disclosure.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for optimizing backup operations in large-scale computing environments.

The present disclosure describes a system and method for efficiently backing up large-scale file systems by intelligently analyzing the file system structure, creating optimized backup jobs, and executing these jobs in a manner that maximizes resource utilization. This approach addresses the challenges posed by complex, deeply nested directory structures and the need for frequent, comprehensive backups in high-performance computing environments. By implementing advanced algorithms and adaptive techniques, the system improves backup efficiency and reliability in scenarios where traditional backup methods often struggle.

Traditional backup systems face several technical problems when dealing with large-scale file systems, particularly those found in research institutions and enterprises with massive datasets. These systems often exhibit inefficiency in traversing deep directory structures, leading to prolonged backup times that can exceed available backup windows. Furthermore, the suboptimal creation of backup jobs frequently results in poor resource utilization, exacerbating performance issues. Many existing systems also lack the ability to adapt to varying file system characteristics and changing system resources, leading to inconsistent backup performance. Additionally, these systems often encounter bottlenecks in data transfer due to limited network path utilization, further hindering backup efficiency.

Aspects of the present disclosure provide technical solutions to these problems through a combination of approaches. In some examples, a system implements a depth-restricted directory search that navigates complex file systems, reducing the time required for an initial file system analysis. Intelligent creation and sorting of backup jobs, based on comprehensive file system analysis and historical performance data, work to optimize the backup process. Some embodiments employ dynamic randomization and resource-aware dispatching of backup jobs to maximize system resource utilization, adapting to real-time conditions. Furthermore, the utilization of multiple network paths enhances data transfer rates during backup operations, addressing common bandwidth limitations.

These technical solutions offer advantages over traditional backup methods. The depth-restricted search capability reduces the time required to analyze large file systems, enabling more frequent and efficient backups even in rapidly changing environments. The intelligent job creation and sorting lead to more balanced backup operations, improving overall system performance and resource utilization. Dynamic job randomization and resource-aware dispatching ensure optimal use of available system resources, adapting to changing conditions in real-time and preventing resource bottlenecks. The multi-path network utilization increases backup throughput, reducing backup windows and minimizing impact on production systems. In certain aspects, these improvements enable organizations to maintain robust data protection strategies even as their data volumes and complexity grow, without requiring proportional increases in backup infrastructure or time windows.

### Example System for Performing Backup Operations

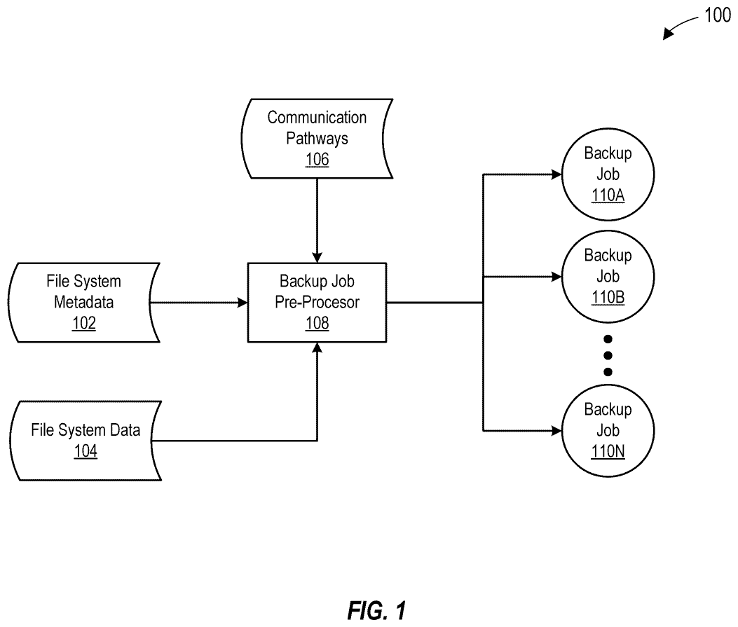

FIG. 1 depicts a system for creating one or more backup jobs 100 in accordance with examples of the present disclosure. In certain aspects, the system for creating one or more backup jobs 100 represents a comprehensive solution designed to optimize and manage backup operations in complex computing environments. In certain aspects, the system for creating one or more backup jobs 100 addresses one or more challenges associated with backing up large-scale file systems, particularly those found in high-performance computing (HPC) or enterprise environments.

In some aspects, the system for creating one or more backup jobs 100 may be implemented as a software suite running on dedicated backup hardware. In such an implementation, specialized optimization of the backup process can occur while minimally impacting the performance of one or more production systems. The system for creating one or more backup jobs 100 may utilize multi-core processors and high-speed memory to efficiently process large volumes of file system metadata and backup job information.

The system for creating one or more backup jobs 100 may incorporate machine learning algorithms to continuously improve its backup job creation strategies. By analyzing historical backup performance data, the system can adapt its job splitting and scheduling algorithms to optimize for factors such as backup window duration, network utilization, and storage efficiency. In some examples, the system for creating one or more backup jobs 100 may provide a modular architecture, allowing for integration with various backup software solutions and storage technologies. This flexibility enables organizations to leverage their existing investments in backup infrastructure while benefiting from the advanced job creation capabilities of the system.

The system for creating one or more backup jobs 100 may also include robust logging and reporting features, providing detailed insights into the backup job creation process. These features can help administrators identify bottlenecks, track performance trends, and demonstrate compliance with data protection policies.

In examples, the file system metadata 102 comprises information about the structure and attributes of a file system. In some aspects, this metadata includes details such as file names, directory structures, file sizes, creation dates, modification dates, access permissions, and ownership information. For example, the file system metadata 102 may contain information about a directory named “research_data” that contains subdirectories for different research projects, each with its own set of files and access permissions.

The file system metadata 102 may also include information about the relationships between files and directories, such as parent-child relationships in the directory hierarchy. This metadata can be used to efficiently navigate the file system and locate specific files or directories. For instance, the metadata can indicate that a file named “experiment_results.csv” is located in the “data_analysis” subdirectory of the “project_alpha” directory.

The file system metadata 102 may also include more advanced file system features, such as symbolic links, hard links, extended attributes, and alternate data streams. In some examples, the system can employ efficient data structures to store and process the file system metadata 102. These data structures can include, but are not limited to, B-trees, hash tables, or specialized graph databases optimized for representing hierarchical file system structures. Such optimizations can significantly improve the speed of metadata analysis and backup job creation. Additional examples of metadata may include, but are not limited to, file and directory names (e.g., “project_alpha”, “data_analysis.py”), file sizes (e.g., 1.5 GB, 2.3 MB), creation, modification, and access timestamps (e.g., 2024-06-25 14:30:00 UTC), file permissions and ownership information (e.g., read-write-execute permissions for owner, read-only for others), file types and extensions (e.g., .txt, .csv, .jpg), directory hierarchy information (e.g., parent-child relationships between directories), symbolic link targets and hard link information, extended attributes or alternate data streams, and/or file system-specific flags or markers (e.g., compressed, encrypted, sparse).

In some aspects, the system for creating one or more backup jobs 100 may implement incremental metadata updates to minimize the time and resources required to maintain an up-to-date view of the file system. By focusing on changes since the last backup, the system for creating one or more backup jobs 100 can quickly identify areas of the file system that require attention without needing to rescan unchanged portions.

In certain aspects, the file system data 104 represents the actual content of the files stored in the file system. This data can include a wide variety of file types and formats, depending on the nature of the computing environment and the work being performed. For example, in a research setting, the file system data 104 may include raw experimental data files, processed results, scientific papers in various stages of completion, and software code used for data analysis.

The file system data 104 can also encompass large datasets used in fields such as bioinformatics, where a single directory can contain millions of small files representing genetic sequences or other biological data. In a high-performance computing environment, the file system data 104 could include input files for complex simulations, intermediate results from long-running computations, and final output data from completed analyses.

In some aspects, the file system data 104 may encompass a wide variety of file types, each with its own backup considerations. For example, large binary files can benefit from block-level incremental backups, while small text files can be more efficiently handled with file-level backups. The system may analyze file types and sizes to determine the most appropriate backup strategies. The file system data 104 may also include special file types that may need specific handling during backup. These could include databases, virtual machine disk images, or application-specific file formats. The system may incorporate plugins or modules to ensure proper backup of these special file types.

In some examples, the system for creating one or more backup jobs 100 may perform data analysis on the file system data 104 to identify patterns or characteristics that can inform backup strategies. Such patterns or characteristics could include identifying highly compressible data, detecting duplicate files across the file system, or recognizing files that change frequently versus those that remain static. The system for creating one or more backup jobs 100 may also consider the distribution of file system data 104 across different storage tiers or devices. For instance, data stored on high-speed SSDs can be prioritized differently in backup jobs compared to data on slower archival storage.

Examples of file system data 104 can include, but are not limited to, text files containing source code (e.g., Python scripts, C++ header files), binary executable files, document files in various formats (e.g., PDF, DOCX, LaTeX), image files (e.g., JPEG, PNG, TIFF), audio and video files (e.g., MP3, MP4, WAV), database files (e.g., SQLite databases, MySQL data files), compressed archives (e.g., ZIP, TAR, GZ), virtual machine disk images, scientific data formats (e.g., HDF5, NetCDF), and/or log files and system configuration files.

In some aspects, the communication pathways 106 facilitate the exchange of information between various components of the system for creating one or more backup jobs 100. These pathways can include internal system buses, network connections, and other data transfer mechanisms. For example, the communication pathways 106 can include high-speed interconnects within a supercomputer that allow rapid access to the file system metadata 102 and file system data 104. In some aspects, the communication pathways 106 may include high-speed internal buses for rapid data transfer between system components. These could leverage technologies such as PCIe or NVMe for minimal latency and maximum throughput when processing file system metadata and creating backup jobs. In some aspects, the communication pathways 106 may also encompass network connections for communicating with remote file systems, backup clients, and storage devices. These could include Ethernet, InfiniBand, or Fibre Channel connections, each offering different performance characteristics and suited to different backup scenarios.

In some examples, the system for creating one or more backup jobs 100 may implement advanced networking features within the communication pathways 106, such as multipathing for increased throughput and redundancy, or software-defined networking for dynamic optimization of data flows. In some aspects, these features can help ensure that network resources are used efficiently during backup operations. The communication pathways 106 may also include APIs and inter-process communication mechanisms that allow different components of the backup system to interact. These could be based on technologies like gRPC, REST, or message queues, enabling flexible and scalable system architectures.

Examples of communication pathways 106 can include, but are not limited to, internal system buses (e.g., PCI Express, NVMe), local area network connections (e.g., Ethernet, InfiniBand), storage area network protocols (e.g., Fibre Channel, ISCSI), wide area network links (e.g., leased lines, VPN tunnels), inter-process communication mechanisms (e.g., shared memory, message queues), remote procedure call (RPC) protocols, RESTful API communications, publish-subscribe messaging systems, memory-mapped file I/O, and/or direct memory access (DMA) channels.

In some aspects, the backup job pre-processor 108 analyzes the file system and prepares one or more backup jobs, such as backup jobs 110A-110N. In certain aspects, the backup job pre-processor 108 can examine the file system metadata 102 and file system data 104 to prepare one or more backup jobs, such as backup jobs 110A-110N. The backup job pre-processor 108 may implement algorithms to efficiently traverse the file system structure and identify changes since the last backup operation. For example, the backup job pre-processor 108 may use depth-restricted searches to explore the directory structure up to a certain level, allowing for parallel processing of different branches of the file system tree. The backup job pre-processor 108 may also implement sorting and randomization techniques to modify and/or optimize an order in which backup jobs are created and executed, which helps to provide a more balanced distribution of workload.

In some aspects, the backup job pre-processor 108 may employ graph analysis techniques to understand the structure of the file system and identify optimal points for splitting backup jobs. Such a technique could involve finding natural boundaries in the directory structure or recognizing clusters of related files that should be backed up together. The backup job pre-processor 108 may utilize historical backup data and performance metrics to inform its job creation strategies. By analyzing patterns in previous backups, it can predict which areas of the file system are likely to have changed and prioritize them in the backup process.

In some examples, the backup job pre-processor 108 can implement parallel processing capabilities to handle large file systems. Such parallel processing capabilities could involve distributing the metadata analysis workload across multiple CPU cores or even multiple nodes in a cluster, allowing for rapid job creation even for massive datasets. In some aspects, the backup job pre-processor 108 may also incorporate load balancing features to ensure that created backup jobs are evenly distributed across available resources. This could involve considering factors such as network topology, storage device capabilities, and the current load on backup server components.

The backup job pre-processor 108 may implement various algorithms and techniques, including but not limited to, depth-first or breadth-first traversal of the directory structure, parallel processing of multiple directory branches, change detection based on file modification timestamps or checksums, file grouping strategies to optimize backup performance, load balancing algorithms to distribute work across available resources, prioritization of backup tasks based on data importance or change frequency, deduplication analysis to identify redundant data, compression algorithm selection based on file types, incremental backup planning to capture only changed data, and/or handling of special file types (e.g., sparse files, continuous databases).

In certain aspects, the backup jobs 110A-110N may represent individual backup tasks created by the backup job pre-processor 108. Each backup job 110A-110N can correspond to a specific subset of the file system that needs to be backed up. For instance, backup job 110A can be responsible for backing up all files in the “project_alpha” directory, while backup job 110B could handle the “project_beta” directory.

These backup jobs can be tailored to different types of backup operations. For example, some backup jobs can perform full backups of entire directories, while others can focus on incremental backups that only capture changes since the last backup. The backup jobs 110A-110N can also be designed to utilize multiple network paths or storage targets, allowing for parallel execution and improved overall backup performance.

In some aspects, each backup job (110A, 110B, . . . , 110N) may contain detailed instructions for the backup client, including the exact files or directories to be backed up, the type of backup to perform (e.g., full, incremental, differential), and any specific handling instructions for special file types. The backup jobs 110A-110N may incorporate intelligent ordering to optimize backup performance. For example, jobs for frequently changing data can be scheduled earlier in the backup window, while jobs for static archival data can be scheduled later or deferred to off-peak hours or may be ordered temporally later in a backup process.

In some examples, the backup jobs 110A-110N can include built-in error handling and retry logic. Such built-in error handling and retry logic could involve specifying alternative paths or methods for backing up data if the primary approach fails, ensuring resilience in the face of network or storage issues. The system may dynamically adjust the number and composition of backup jobs based on real-time conditions. For instance, if certain resources become constrained, the system can consolidate multiple small jobs into larger ones to reduce overhead, or conversely, split large jobs into smaller ones to enable better parallelization.

The backup jobs 110A-110N may include, but are not limited to, full backup of a specific directory or file set, incremental backup capturing only changed files since the last backup, differential backup of files modified since the last full backup, synthetic full backup combining previous backups, file-level backup of selected files matching specific criteria, block-level backup for efficient handling of large files, application-consistent backup of databases or other complex applications, bare-metal backup of entire system partitions, snapshot-based backup leveraging file system or storage system capabilities, and/or continuous data protection (CDP) style backup capturing changes in real-time.

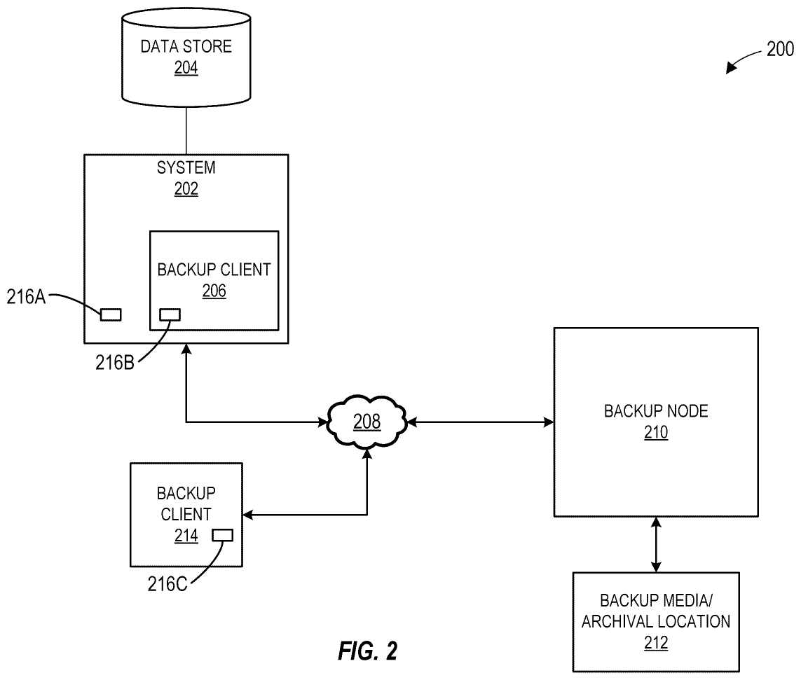

FIG. 2 illustrates an example backup system 200 in accordance with aspects of the present disclosure. The backup system 200 can include a system 202, a data store 204, a backup client 206, a network or communication pathway 208, a backup node 210, and a backup media/archival location 212. In some examples, the system 202 may represent a computing system to be backed up, such as a server, high-performance computing (HPC) system, or other data processing device. In some aspects, the system 202 may be a standalone server hosting various applications and services. In other aspects, the system 202 may be part of a larger cluster or distributed computing environment. The system 202 can include one or more processors, memory, and storage devices, which may contain valuable data that needs protection through regular backups.

In some examples, the system 202 may run specialized software or perform computationally intensive tasks, such as scientific simulations, data analytics, or machine learning operations. The system 202 may generate large amounts of data during its operation, which can be stored locally or on associated storage systems. The system 202 may incorporate various types of storage, including high-speed SSDs for active data, large capacity HDDs for near-line storage, and possibly tape or optical media for archival purposes. In certain aspects, the backup solution handles this diverse storage landscape, potentially prioritizing backups based on the criticality and change rate of data on different storage tiers.

In some examples, the system 202 can run multiple virtual machines or containers, each with its own data protection requirements. The example backup system 200 would need to be aware of these virtualized environments, potentially leveraging APIs or integration points to ensure consistent backups of all virtual entities. In some examples, the system 202 may also include specialized hardware accelerators, such as GPUs or FPGAs, which could generate unique data patterns or volumes.

In certain examples, the data store 204 represents an optional data storage system in communication with the system 202. In some aspects, the data store 204 may be a separate storage area network (SAN) or network-attached storage (NAS) device. In other aspects, the data store 204 may be a distributed file system spanning multiple nodes in a cluster. The data store 204 can provide additional storage capacity for the system 202 and may contain data that also needs to be included in backup operations. The data store 204 may use various storage technologies, such as solid-state drives (SSDs), hard disk drives (HDDs), or a combination of both. In some examples, the data store 204 may implement data protection mechanisms like RAID (Redundant Array of Independent Disks) for improved reliability and performance.

In some aspects, the backup client 206 may be a software component installed on the system 202 that facilitates the backup process. In some aspects, the backup client 206 may be responsible for identifying files and data that need to be backed up. In other aspects, the backup client 206 may handle the actual data transfer to the backup node 210. The backup client 206 can communicate with other components of the backup system 200 to coordinate backup operations. In some examples, the backup client 206 may include features for data compression, encryption, or deduplication to optimize the backup process. The backup client 206 may also maintain logs of backup activities and provide status updates to system administrators.

In some aspects, the backup client 206 may implement changed block tracking or similar technologies to efficiently identify modifications since the last backup. This can reduce the time required to perform incremental backups, especially for large files or databases that experience small, frequent changes. The backup client 206 may offer application-aware backup capabilities, allowing it to interact with databases, email servers, or other complex applications to ensure consistent backups. This could involve quiescing applications, flushing buffers, or using application-specific APIs to capture a coherent state of the data.

In some examples, the backup client 206 can incorporate local processing capabilities to optimize data before transmission. This could include compression, encryption, or preliminary deduplication, reducing the load on network resources and the central backup infrastructure. The backup client 206 may also include self-diagnostic and reporting features. Such feature could help identify local issues that can impact backup performance or completeness, such as file system corruption, disk failures, or resource constraints.

In certain aspects, the network or communication pathway 208 represents the infrastructure through which data and control information flow between various components of the backup system. The network or communication pathway 208 can affect the performance and reliability of the overall backup process. In some aspects, the communication pathway 208 may incorporate multiple physical and logical networks to segregate different types of traffic. For example, backup data can flow over a dedicated high-bandwidth network, while control and metadata information can use a separate, lower-bandwidth but more reliable network.

The network or communication pathway 208 represents the data transfer infrastructure connecting various components of the backup system 200. In some aspects, the network or communication pathway 208 may be a local area network (LAN) using technologies such as Ethernet or InfiniBand. In other aspects, the network or communication pathway 208 may include wide area network (WAN) connections for remote backup scenarios. The communication pathway 208 can support various network protocols and may include multiple redundant paths for improved reliability. In some examples, the communication pathway 208 may implement quality of service (QoS) mechanisms to prioritize backup traffic and ensure consistent performance. The network or communication pathway 208 may also include security measures such as encryption and access controls to protect data in transit.

In some aspects, the backup node 210 provides a central coordination point for backup operations, managing the flow of data between backup clients and storage destinations. In examples, the backup node 210 can orchestrate complex backup scenarios and optimizing resource utilization. In some aspects, the backup node 210 may implement intelligent job scheduling algorithms. These intelligent job scheduling algorithms may consider factors such as backup window constraints, storage device capabilities, network topology, and historical performance data to efficiently allocate backup tasks across available resources.

The backup node 210 may incorporate data processing capabilities such as global deduplication, where redundant data is identified and eliminated across all backup sources. By incorporating such capabilities, the backup node 210 can reduce storage requirements and network traffic, especially in environments with many similar systems or shared data. In some examples, the backup node 210 can provide policy-based management features, allowing administrators to define high-level data protection objectives, which the node then translates into specific backup jobs and schedules.

The backup node 210 may also include logging and auditing capabilities. These features can help track all backup and restore operations, providing valuable information for troubleshooting, capacity planning, and compliance reporting.

In some examples, the backup node 210 may be a dedicated system that manages the backup process and acts as an intermediary between the systems being backed up and the final backup storage. In some aspects, the backup node 210 may receive data from multiple backup clients and coordinate the storage of this data. In other aspects, it may handle tasks such as data deduplication, compression, and encryption before writing to the backup media.

The backup node 210 may run specialized backup software that manages backup schedules, monitors backup jobs, and provides reporting and analytics capabilities. In some examples, the backup node 210 may implement features like data staging, where backups are initially stored on fast disk storage before being moved to slower, more cost-effective long-term storage.

The backup media/archival location 212 represents the final storage destination for backed-up data. In some aspects, this may be a tape library for long-term data archival. In other aspects, the backup media/archival location 212 could be a disk-based storage system or cloud storage service. The backup media/archival location 212 may implement various data protection mechanisms, such as error-correcting codes or redundant storage, to ensure the long-term integrity of backed-up data.

In some examples, the backup media/archival location 212 may support features like data immutability or write-once-read-many (WORM) capabilities to protect against data tampering or accidental deletion. The backup media/archival location 212 may also implement tiered storage strategies, automatically moving less frequently accessed backups to more cost-effective storage tiers.

The backup client 214 may be similar to or the same as the backup client 206, but installed on a different system. In some aspects, the backup client 214 may be tailored to the specific needs of the system it's installed on, such as handling particular file types or applications. In other aspects, the backup client 214 may be a standardized client used across multiple systems in the organization. The backup client 214 may implement features like changed block tracking or file system monitoring to identify data that needs to be backed up. In some examples, the backup client 214 may support application-aware backups, ensuring consistent backups of complex applications like databases or email servers.

The backup job pre-processor 216A, 216B, and/or 216C may be the same as or similar to the backup job pre-processor 108 described in relation to FIG. 1. In some aspects, multiple instances of the backup job pre-processor (216A, 216B, 216C) may be deployed to handle different aspects of backup job preparation or to distribute the workload across multiple systems. The backup job pre-processor 216A-C may analyze the file system structure and metadata to efficiently plan backup jobs. In some examples, the backup job pre-processor 216A-C may implement intelligent algorithms to group files for optimal backup performance, such as combining many small files into larger backup units or splitting large files into manageable chunks. The backup job pre-processor 216A-216C may also prioritize backup jobs based on factors like data criticality, change frequency, or available system resources.

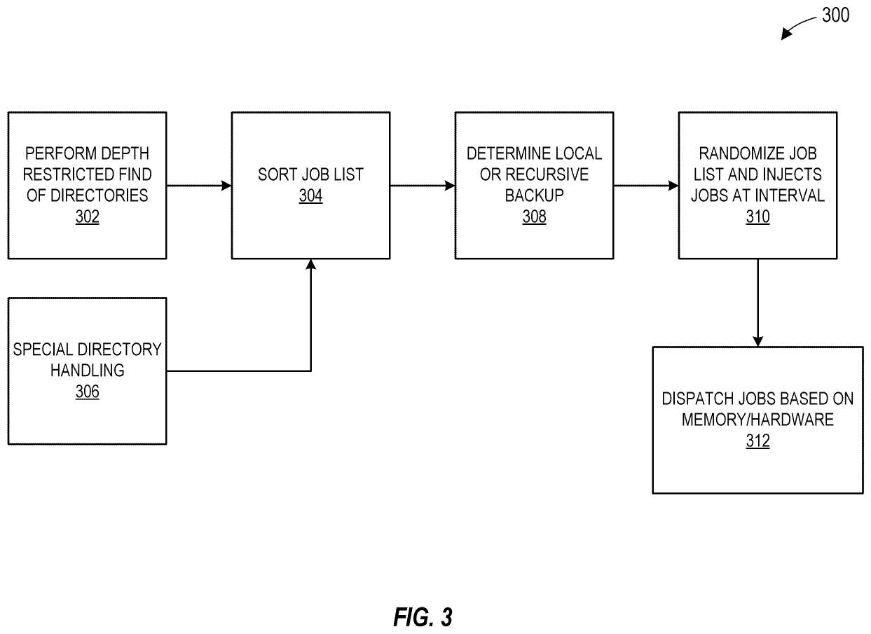

FIG. 3 depicts a flowchart 300 that represents a series of operations that may be performed by a backup system, such as the one described in FIG. 2. In some aspects, these operations may be carried out by the backup job pre-processor (216A-216C in FIG. 2) or similar components. The operations provided in flowchart 300 addresses one or more challenges associated with backing up complex file systems, such as those found in high-performance computing environments or large enterprise systems. In some aspects, the flowchart 300 may be implemented as a modular software system, allowing organizations to selectively enable or customize specific steps based on their unique requirements. This modularity can provide flexibility in adapting the backup optimization process to various environments, from small businesses to large enterprises or research institutions.

The operations outlined in flowchart 300 may incorporate feedback loops and adaptive mechanisms. These features allow the system to learn from previous backup operations, continuously refining its approach to achieve optimal performance over time. For instance, the system can adjust depth restrictions or randomization parameters based on observed backup durations and resource utilization patterns.

In some examples, the flowchart 300 can be integrated with a broader IT service management framework. This integration could allow the backup optimization process to consider factors such as scheduled maintenance windows, peak business hours, or compliance requirements when planning and executing backup operations. The flowchart 300 may also include logging and telemetry capabilities at each step. These features can provide valuable insights into the backup process, helping administrators identify bottlenecks, track performance trends, and demonstrate compliance with data protection policies.

In some aspects, operation 302 involves performing a depth-restricted find of directories. In this operation, the backup system can explore the directory structure of the file system to be backed up, but may limit the depth of its search to a predetermined level. This depth restriction serves multiple purposes in the backup process.

In some aspects, the depth-restricted find helps to manage the complexity of deeply nested directory structures. By limiting the depth of the initial search, the system can more efficiently process higher-level directories without getting bogged down in due in part to the depth of directory trees. In some examples, the depth restriction may be configurable, allowing administrators to adjust it based on the specific characteristics of their file system.

The depth-restricted find operation may employ parallel processing techniques to speed up the directory traversal. This could involve spawning multiple worker threads or processes, each responsible for exploring a different branch of the directory tree up to the specified depth limit. In some examples, operation 302 can incorporate smart caching mechanisms to store and reuse directory structure information across multiple backup operations. This can significantly reduce the time required for subsequent backups, especially in environments where the high-level directory structure changes infrequently. The depth-restricted find operation may also include preliminary data analysis capabilities. As the depth-restricted find operation traverses the directory structure, it can gather statistics on file types, sizes, and modification patterns, which can inform later steps in the backup optimization process.

In some aspects, operation 304 may involve sorting the job list generated from the depth-restricted directory find. This sorting operation can organize the potential backup jobs in a way that can improve overall backup efficiency. The sorting criteria may vary depending on the specific needs of the backup system and the characteristics of the data being backed up. In some aspects, the sorting may be based on factors such as directory size, file count, or estimated backup time. In other aspects, sorting can prioritize certain types of data or directories based on their importance or frequency of change. The sorted job list provides a structured approach to tackling the backup tasks, potentially allowing for better resource utilization and more predictable backup times.

In some examples, operation 304 may offer multiple predefined sorting strategies that administrators can choose from based on their specific needs. Such strategies could include strategies optimized for minimizing backup window duration, reducing network usage, or prioritizing critical data protection. The sorting process may also consider dependencies between different parts of the file system. For instance, it can prioritize backing up configuration files or databases before the data files they reference, ensuring a consistent backup state.

In certain aspects, operation 306 may involve performing special directory handling. In examples, operation 306 recognizes that certain directories may require unique treatment during the backup process due to their content, structure, or role in the overall system. Special handling can help ensure that these directories are backed up correctly and efficiently. In some examples, special directory handling can involve using specific backup methods for directories containing databases or application data. In other cases, it can mean applying different compression or encryption settings to directories with sensitive information. This operation allows the backup system to adapt its approach based on the specific requirements of different parts of the file system.

In some examples, operation 306 could include intelligent detection mechanisms to automatically identify directories that require special handling. This could involve analyzing file patterns, checking for the presence of specific marker files, or integrating with system configuration databases. The special directory handling operation may also implement policy-based management features. Thus, administrators could define rules specifying how different types of directories should be treated, with the system automatically applying the appropriate handling methods based on these policies.

In certain aspects, operation 308 involves determining whether to perform a local or recursive backup for each item in the job list. This decision is made based on the results of the previous steps and the characteristics of each directory or file set. The choice between local and recursive backup can significantly impact the efficiency and completeness of the backup operation.

In some aspects, a recursive backup can be chosen for directories that are at or near the depth limit set in operation 302, while one or more local backups can be used for higher-level directories that need a more comprehensive backup. The system may use various criteria to make this determination, such as the number of subdirectories, the total size of the directory, or specific flags set during the special directory handling step.

Operation 310 involves randomizing the job list and injecting jobs at intervals. This step introduces an element of variability into the backup process, which can help distribute the backup workload more evenly over time and across system resources. Randomization can be particularly beneficial in environments where certain parts of the file system tend to change more frequently than others. In some examples, the randomization can involve shuffling the order of jobs within the list. In other cases, it can mean interspersing different types of backup jobs (e.g., full backups, incremental backups) throughout the list. The injection of jobs at intervals can help manage system load by spreading out resource-intensive operations over time.

The job injection process may utilize adaptive timing mechanisms. Rather than inserting jobs at fixed intervals, the system could dynamically adjust the injection timing based on observed system performance, network utilization, or storage device load, memory utilization, and/or communication bandwidth availability. In some examples, operation 310 can incorporate priority-weighted randomization. This approach would ensure that high-priority backup jobs have a higher probability of being scheduled earlier in the process while still maintaining an overall element of randomness. The randomization and job injection step may also include conflict resolution mechanisms. These would detect and resolve potential resource conflicts between randomized jobs, ensuring that the resulting schedule remains feasible and efficient.

In certain aspects, operation 312 involves dispatching jobs based on memory and hardware considerations. This final operation 312 in the flowchart 300 takes into account the current state of system resources when initiating backup jobs. By considering factors such as available memory, CPU usage, and storage I/O capacity, the backup system can optimize job execution to make the most efficient use of available resources. In some aspects, operation 312 may involve dynamically adjusting the number of concurrent backup jobs based on system load. In other aspects, it can prioritize certain types of backup jobs when specific hardware resources are available. This resource-aware job dispatching helps ensure that the backup process runs smoothly without overwhelming the system or impacting other critical operations.

In some aspects, a job dispatching algorithm at operation 312 may employ sophisticated resource modeling techniques. These could involve creating real-time models of system memory usage, CPU utilization, storage I/O capacity, and network bandwidth, allowing for precise allocation of jobs to resources. The dispatching process may incorporate predictive load balancing features. By analyzing historical performance data and current system trends, the system can anticipate potential resource bottlenecks and proactively adjust job allocation to maintain optimal performance. In some examples, operation 312 could include dynamic resource provisioning capabilities. For example, if the system detects that current hardware resources are insufficient for efficient job execution, operation 312 could automatically request additional resources (e.g., spinning up new virtual machines or containers) to handle the workload. Operation 312 may also implement advanced queuing and prioritization mechanisms to allow the system to manage complex job dependencies, ensure fair resource allocation across multiple backup clients, and dynamically adjust job priorities based on ongoing system events or administrative inputs.

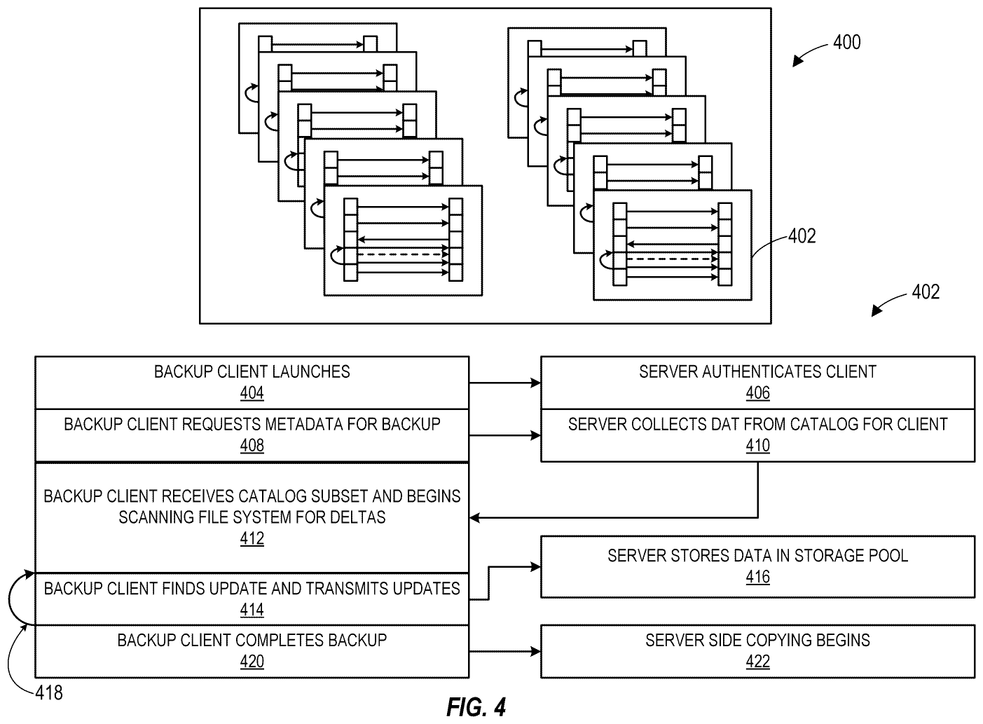

FIG. 4 illustrates a plurality of backup jobs 400 and an example backup job 402 in accordance with aspects of the present disclosure. In some aspects, FIG. 4 depicts the flow of operations and data between a backup client and a server during a backup process.

In some aspects, the plurality of backup jobs 400 represents a set of individual backup tasks that may be executed concurrently or sequentially as part of a larger backup operation. In some aspects, these jobs may be created by the backup job pre-processor described in previous drawings. Each job within the plurality of backup jobs 400 may target specific directories, files, or data sets within the system being backed up. In some examples, the plurality of backup jobs 400 may include one or more parameters to indicate a backup type, such as one or more of full backups, incremental backups, and differential backups. The composition and ordering of these jobs may be determined by the randomization and job injection processes described in relation to FIG. 3. In some examples, an example backup job 402 depicts additional details that may be involved in executing a single backup job from the plurality of backup jobs 400. For example, this job illustrates an interaction between the backup client and the server throughout a backup process. The example backup job 402 may be representative of the general workflow followed by each job in the backup jobs 400.

In some aspects, the example backup job 402 may be tailored to specific types of data or system configurations. In other aspects, the example backup job 402 may represent a standardized process applied across various data types and systems. At operation 404, the backup client may be launched. This operation may involve initializing the backup software, loading configuration settings, and preparing system resources for the backup operation. In some aspects, the launch process may include verifying the availability of network connections and the readiness of the backup server.

In some examples, the backup client may perform pre-backup checks during the launch operation 404, such as ensuring sufficient disk space for temporary files or verifying the integrity of previous backup data. In some aspects, operation 406 involves the server authenticating the client. This step ensures that only authorized clients can initiate backup operations and access the backup infrastructure. In some aspects, authentication may involve the exchange of digital certificates or tokens. In other aspects, it may use more traditional username and password mechanisms. The authentication process may also include verifying the client's backup permissions and access rights. In some examples, the server may apply role-based access controls to determine which data sets the client is allowed to back up.

At operation 408, the backup client may request metadata for the backup operation from the server. This metadata may include file system information and information about previous backups, such as the last backup time for each file or directory. In some aspects, the metadata request may be scoped to the specific directories or file sets targeted by the current backup job. The metadata request may also include queries about backup policies, retention periods, or other configuration details that can affect the current backup operation. In some examples, the client may request incremental metadata updates if it has cached previous metadata locally.

In some aspects, at operation 410 the server can collect data from its catalog for the client. The catalog may contains comprehensive information about all backed-up data, including file names, sizes, modification times, and the location of backup data on storage media. In some aspects, the server may optimize this data collection process based on the specific metadata requested by the client. The server may apply filters or queries to efficiently retrieve only the relevant catalog data for the current backup job. In some examples, the server can use indexing or caching mechanisms to speed up catalog data retrieval, particularly for large backup systems with extensive catalogs.

At operation 412, the backup client can receive a catalog subset from the server and may begin scanning the file system for changes. In some aspects, operation 412 involves comparing the received metadata with a current state of the file system to identify files that need to be backed up. In some aspects, the client may use efficient file system traversal algorithms to minimize the time spent on this scanning process. The file system scan may also involve checking for changes in file attributes, such as permissions or ownership, even if the file content hasn't changed. In some examples, the client may use change journals or other file system tracking mechanisms to quickly identify modified files without needing to scan the entire file system.

At operation 414, the backup client may find or discover updates and transmit them to the server. In some examples, this operation involves sending the actual data of changed or new files to the backup server. In some aspects, the client may apply compression or deduplication techniques to reduce the amount of data transferred over the network. The client may also break large files into smaller chunks for more efficient transfer and to allow for resumable uploads in case of network interruptions. In some examples, the client can prioritize the transmission of certain file types or use multiple network connections to parallelize data transfer.

At operation 416, the server can store the received data in its storage pool. This may involve writing the data to disk, tape, or other backup media. In some aspects, the server may perform additional processing on the received data, such as further compression or encryption, before storing it. The storage process may also include updating the server's catalog with information about the newly backed-up data. In some examples, the server can implement data verification procedures to ensure the integrity of the stored backup data.

At operation 418, the client-side copying may begin. This may involve creating redundant copies of the backup data for increased protection or moving data between different storage tiers. In some aspects, this copying process may be performed asynchronously to avoid delaying the client's backup operation. The client-side copying may also include creating synthetic full backups by combining previous full and incremental backups. In some examples, this step can involve data replication to off-site locations for disaster recovery purposes. At operation 420, the backup client completes the backup operation. This may involve finalizing logs, releasing system resources, and potentially preparing summary reports of the backup operation. In some aspects, the client may perform post-backup verification to ensure all intended data was successfully backed up. The completion operation 420 may also include scheduling the next backup operation or updating system status indicators to reflect the successful backup. In some examples, the client can initiate cleanup operations, such as deleting temporary files or updating local caches.

Throughout the backup job, various types of data may be exchanged between the client and server components. This can include, but is not limited to, authentication credentials and security tokens; metadata about files and directories, including names, sizes, and modification times; backup catalog information from previous backup operations; file and directory listings for change detection; actual file contents and data streams for items being backed up; compression and encryption parameters; job status updates and progress information; error messages and warning notifications; configuration settings and backup policies; and summary reports and backup statistics.

The efficient exchange and processing of this data contribute to the overall performance and reliability of the backup system. At operation 422, the server-side copying begins. In some aspects, server-side copying may involve creating redundant copies of the backup data for increased protection. This can include making a plurality of copies on different storage media or replicating data to geographically diverse locations. Such redundancy can enhance data durability and facilitate disaster recovery scenarios. In some examples, server-side copying can encompass data movement between different storage tiers. For instance, the server may initially store backup data on high-speed disk arrays for quick access, then gradually move older backups to more cost-effective storage solutions like tape libraries or cloud storage. This tiered approach can optimize storage costs while maintaining appropriate access times for different backup vintages.

The server-side copying process may also involve creating synthetic full backups. In this scenario, the server combines a previous full backup with subsequent incremental backups to create a new, up-to-date full backup without requiring the client to retransmit all the data. This technique can significantly reduce network traffic and the time required for full backups.

In some aspects, operation 422 may include data transformation operations. For example, the server can apply additional compression to the backup data, convert it to a different format for long-term archival, or generate indexes to facilitate faster searches and restores. These operations are performed on the server side to minimize the computational burden on the client systems. In some examples, server-side copying can also encompass data validation and integrity checks. The server may calculate checksums or use other verification methods to ensure that the copied data matches the original backup. In some examples, this step can include periodic “scrubbing” of backup data to detect and correct any bit rot or storage media degradation.

In some examples, server-side copying operations may occur asynchronously to the main backup job. This allows the backup client to consider its task complete (as in operation 420) while the server continues to manage and optimize the stored backup data. Such asynchronous processing helps to minimize the impact of these additional operations on the overall backup window.

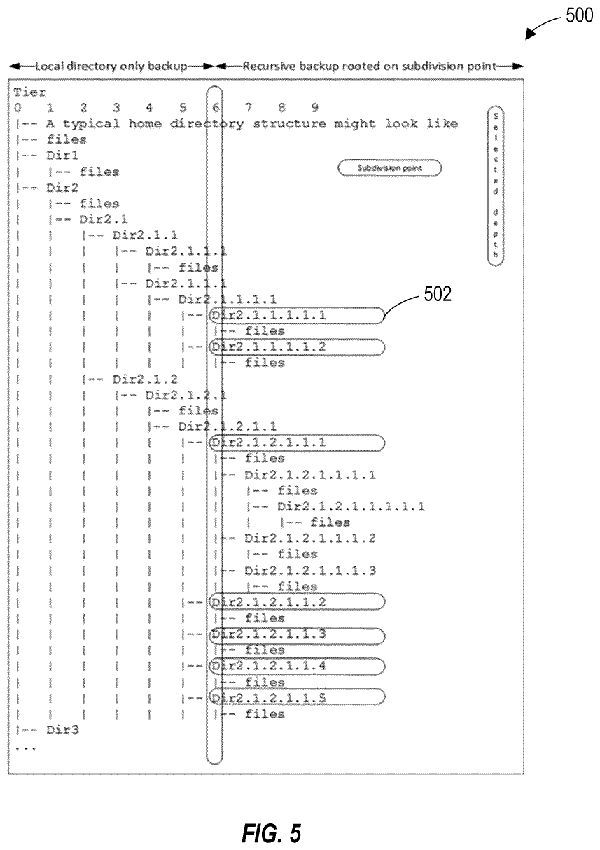

FIG. 5 illustrates an example file system 500 and an example file tree or directory structure 502 in accordance with aspects of the present disclosure. In some aspects, FIG. 5 provides a visual representation of how a typical file system can be organized and how the backup system interacts with this structure to optimize backup operations.

The example file system 500 represents an example of a comprehensive data storage and organization system that manages files and directories on one or more storage devices. This example file system acts as the foundation upon which the backup optimization techniques operate, providing the structure and metadata that inform backup decisions. In some aspects, the example file system 500 may implement advanced features such as journaling, copy-on-write snapshots, or inline data deduplication. These features can significantly impact backup strategies, potentially allowing for more efficient incremental backups or reduced data transfer volumes. The backup system may be designed to detect and leverage these file system capabilities when present.

The file system 500 may support various access protocols and interfaces, such as NFS, SMB, or object storage APIs. This versatility allows the file system to serve diverse computing environments, from traditional server infrastructures to modern cloud-native applications. The backup system can adapt its approach based on the specific access methods available, optimizing data retrieval for each protocol.

In some examples, the example file system 500 can incorporate tiered storage management, automatically moving data between high-performance SSDs and higher-capacity HDDs based on access patterns. The backup system could take these tiers into account when planning backup jobs, potentially prioritizing the backup of data on faster tiers to minimize impact on system performance. The file system 500 may also include built-in data protection features, such as RAID configurations or distributed erasure coding. While these features provide a level of redundancy, they do not obviate the need for backups. Instead, the backup system can work in concert with these features, potentially using them to create more efficient or consistent backup copies.

The example file tree or directory structure 502 illustrates the hierarchical organization of files and directories within the file system. This structure plays a role in how the backup system navigates and processes data during backup operations. In some aspects, the directory structure 502 may exhibit varying depths and breadths across different branches. Some paths can extend many levels deep, while others remain relatively shallow. This variability can be a factor that the backup system's depth-restricted find operation (as described in operation 302 of FIG. 3) can handle in an efficient manner. The directory structure 502 may include various special directory types that require unique handling during backup operations. These could include mount points for different file systems, symbolic links that create circular references, or directories with special permissions or ownership. The backup system's special directory handling capabilities (as outlined in operation 306 of FIG. 3) can be designed to address these cases appropriately.

In some examples, the directory structure 502 (e.g., file tree) may contain a mix of small, numerous files (such as log files or configuration data) and large, monolithic files (like database files or media content). This diversity in file sizes and quantities within different directories informs the backup system's decisions about local versus recursive backups (as described in operation 308 of FIG. 3). The directory structure 502 may also reflect the organizational structure of the data, with different branches corresponding to various departments, projects, or data categories. This logical organization can be leveraged by the backup system when randomizing and prioritizing backup jobs (as detailed in operation 310 of FIG. 3), ensuring that critical or frequently changing areas of the file tree are backed up efficiently.

In accordance with the present disclosure, the backup system may employ intelligent subdivision techniques when processing the directory structure 502 (e.g., file tree). This approach involves identifying optimal points in the directory structure to split backup jobs, balancing factors such as directory size, file count, and historical backup performance. The system may implement adaptive depth restriction, dynamically adjusting the depth of directory traversal based on the characteristics of each branch in the directory structure 502 (e.g., file tree). This allows for more efficient handling of varying directory structures without the need for manual tuning.

In some aspects, the backup system may utilize a graph-based representation of the directory structure 502 (e.g., file tree) internally. This representation can facilitate more advanced analysis and optimization techniques, such as identifying natural boundaries for backup job division or recognizing patterns in data distribution across the file system. The system may also incorporate change rate analysis at various levels of the directory structure 502. By tracking how frequently different parts of the file tree change, the backup system can make more informed decisions about backup frequency, job prioritization, and resource allocation.

In some examples, the backup system can implement a multi-pass approach when processing the directory structure 502 (e.g., file tree). An initial rapid scan could identify high-level structural changes, followed by more detailed analysis of specific branches that have experienced significant modifications since the last backup. The system may also offer visualization tools that allow administrators to explore the directory structure 502 (e.g., file tree) and understand how backup jobs are being created and executed across the directory structure. These tools can provide valuable insights into backup performance and help identify areas where further optimization can be beneficial.

In some examples, the backup job pre-processor analyzes the directory structure of the file system, as illustrated in the example file tree 502. When processing a directory, the pre-processor employs an intelligent algorithm to determine the most efficient backup strategy for that directory and its contents. As the pre-processor traverses the directory structure, it maintains a record of the directories it has encountered. For each directory, it performs the following check: If the pre-processor encounters a directory path that it has not seen before (i.e., the path is not in its record of processed directories), it determines that this directory represents a new branch of the file system that requires comprehensive backup. In this case, the backup job pre-processor generates a backup job that will perform a recursive backup, encompassing the directory and all of its subdirectories and files.

On the other hand, if the pre-processor encounters a directory path that it has seen before (i.e., the path or a parent path is already in its record of processed directories), it recognizes that a recursive backup job has already been created for a parent directory. In this case, to avoid redundant backups and optimize the process, the pre-processor generates a backup job that will perform a local backup, including only the files directly within that directory, without recursing into subdirectories.

This approach ensures that each part of the file system is backed up efficiently, avoiding unnecessary duplication of effort while still providing comprehensive coverage. Such an approach can be effective for handling deep and complex directory structures, as it allows the system to create focused, manageable backup jobs even for extensively nested file systems. By making these intelligent decisions about recursive versus local backups, the backup job pre-processor can reduce the overall time and resources required for the backup process, while still ensuring that all data is properly protected.

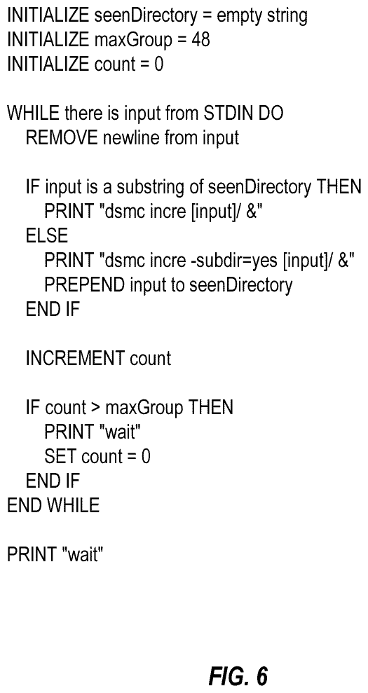

FIG. 6 illustrates a pseudocode representation of an example algorithm for intelligent backup job creation, in accordance with aspects of the present disclosure. This algorithm depicted in FIG. 6 provides a technical solution for efficiently managing backup operations in complex directory structures, particularly in large-scale file systems.

In some examples, the algorithm initializes key variables, including a string to track processed directories (seenDirectory), a maximum group size for parallel processes (maxGroup), and a counter (count). These variables are can be utilized to control the backup job creation process and managing system resources effectively. A feature of the algorithm is its ability to differentiate between previously processed and new directory paths. For each input directory path, the algorithm depicted in FIG. 6 can perform a substring search within the seenDirectory string, which contains a record of all previously processed paths. This efficient search mechanism allows the algorithm depicted in FIG. 6 to quickly determine whether a directory has been encountered before, without the need for complex data structures or time-consuming comparisons.

In some examples, if the current path has been seen before, the algorithm depicted in FIG. 6 generates a local, non-recursive backup command for that specific directory. This approach can be used to optimize the backup process by avoiding redundant backups of subdirectories that have already been addressed by previous recursive backups. The command is formatted as “dsmc incre [directory_path]/&”, where the ampersand ensures background execution, allowing for parallelism. For new, unseen directory paths, the algorithm depicted in FIG. 6 can generate a recursive backup command in the form “dsmc incre-subdir=yes [directory_path]/&”. This ensures comprehensive coverage of new areas in the file system. After processing a new path, it is prepended to the seenDirectory string, updating the record of processed directories. This prepending approach ensures that longer, more specific paths are checked before shorter, more general ones in subsequent iterations.

The algorithm depicted in FIG. 6 incorporates a sophisticated method for managing parallel processes. The algorithm depicted in FIG. 6 can maintain a count of generated backup commands and introduces a ‘wait’ command after every maxGroup number of backup commands. This feature provides a mechanism for controlling the number of concurrent backup processes, preventing system overload and ensuring efficient resource utilization. The maxGroup variable can be adjusted based on system capabilities and backup requirements. Another technical aspect of the algorithm is its use of standard input (STDIN) for receiving directory paths. This choice allows for flexible integration with other system components that can generate or filter directory lists, enhancing the algorithm's versatility and applicability in various backup scenarios.

The algorithm concludes with a final ‘wait’ command, ensuring that all spawned backup processes complete before the job creation phase ends. This helps to ensure that all created backup jobs have finished execution, maintaining data consistency and completeness in the backup process. The pseudocode in FIG. 6 represents a significant advancement in backup job creation for complex file systems. By intelligently differentiating between processed and new directories, implementing controlled parallelism, and optimizing for both local and recursive backups, this algorithm enables more efficient and thorough backup operations. It addresses the technical challenges of backing up large-scale file systems by minimizing redundant operations, optimizing system resource usage, and providing a scalable approach to handling diverse directory structures.

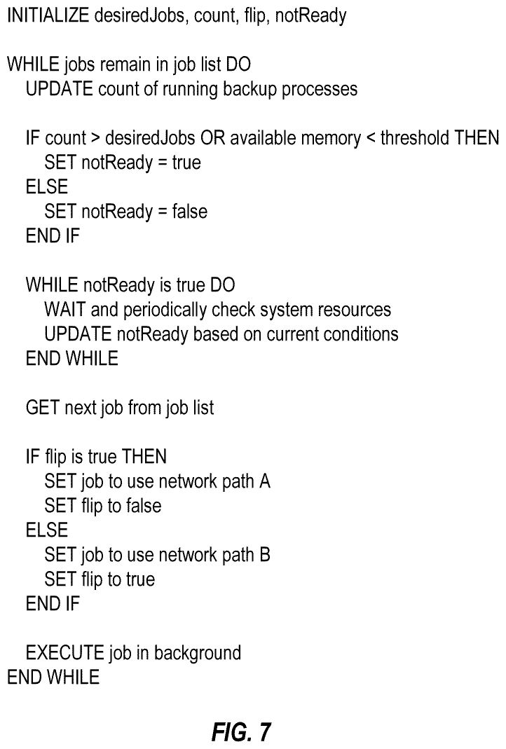

FIG. 7 illustrates a pseudocode representation of an example algorithm for dynamic job dispatching and execution in a backup system, in accordance with aspects of the present disclosure. This algorithm depicted in FIG. 7 builds upon the job creation process outlined in FIG. 6, providing a technical solution for efficiently managing and executing backup jobs while optimizing system resource utilization in complex computing environments.

In some aspects, the algorithm depicted in FIG. 7 initializes variables, including a desired number of concurrent jobs (desiredJobs), a job counter (count), a network path alternator (flip), and a readiness flag (notReady). These variables can be used to control job execution, resource allocation, and load balancing across network paths. In operation, the algorithm depicted in FIG. 7 continuously processes input from a job list, which may be generated by the process described in FIG. 6. For each job, the algorithm assesses the current system state by counting the number of running backup processes. This count is compared against the desired number of concurrent jobs to determine if the system is ready to accept new jobs. This dynamic assessment allows the algorithm to adapt to changing system conditions in real-time.

The algorithm depicted in FIG. 7 can dynamically adjust job execution based on system resource availability. For example, the algorithm can enter a waiting loop when the system is not ready for new jobs, continuously monitoring both the number of running processes and available system memory. This approach ensures that the backup system does not overload the host machine's resources, maintaining system stability and performance. The algorithm periodically checks the system state during this waiting period, allowing it to respond quickly when resources become available. The algorithm can incorporate a method for load balancing across multiple network paths. It alternates between two different server endpoints for job execution, as indicated by the flip variable. This distribution of network load improves overall backup performance by utilizing available network resources more efficiently. This feature addresses the technical problem of network bottlenecks in backup operations, which can be a significant limiting factor in large-scale backup scenarios.

Another technical aspect of the algorithm is its use of background execution for backup jobs. By launching each job as a background process, indicated by the ampersand at the end of the command, the algorithm can maintain control and continue processing the job list without waiting for individual jobs to complete. This asynchronous execution model can enhance the efficiency of the backup process, especially in environments with numerous backup jobs created by the process described in FIG. 6. The algorithm also demonstrates adaptability in its approach to memory management. The algorithm checks available system memory before dispatching new jobs, ensuring that the system maintains sufficient free memory for other critical operations. This prevents memory exhaustion, which could lead to system instability or failure during long-running backup operations.

The pseudocode in FIG. 7 represents an advancement in backup job management, offering a flexible and resource-aware approach to executing backup tasks. By dynamically adapting to system conditions, optimizing resource usage, and implementing intelligent load balancing, this algorithm enables more efficient and reliable backup operations in complex computing environments. Furthermore, the algorithm's design allows for easy modification and extension. For example, the criteria for system readiness could be expanded to include additional factors such as CPU load or I/O wait times. The load balancing mechanism could be extended to support more than two network paths, further distributing the backup workload across available network resources. Thus, FIG. 7 presents a sophisticated solution to the challenges of executing backup jobs in large-scale, resource-constrained environments. It effectively complements the job creation process outlined in FIG. 6, forming a comprehensive approach to optimizing backup operations in complex file systems.

### Example Method for Performing Backup Operations

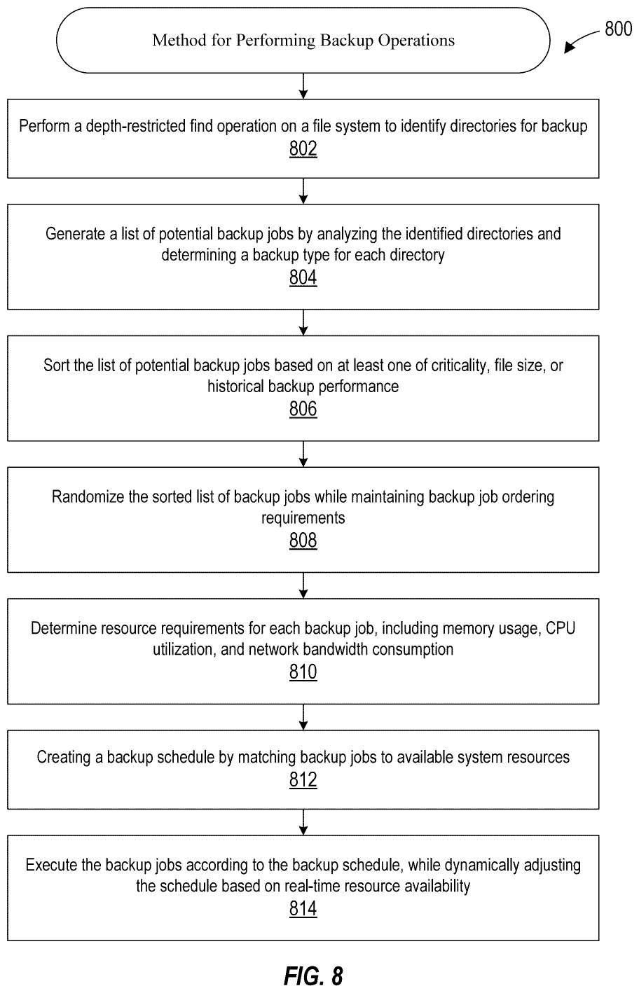

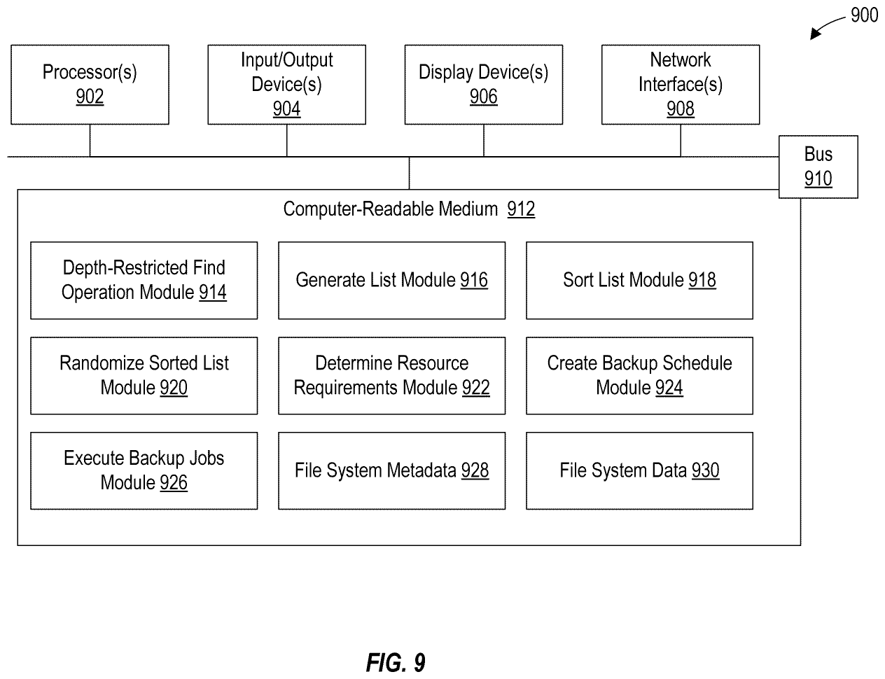

FIG. 8 depicts an example method 800 for performing backup operations in a computing environment. In one aspect, method 800 can be implemented by the backup system 200 of FIG. 2 and/or processing system 900 of FIG. 9.

Method 800 starts at block 802 with performing a depth-restricted find operation on a file system to identify directories for backup. From block 802, method 800 proceeds to block 804 with generating a list of potential backup jobs by analyzing the identified directories and determining a backup type for each directory. At block 806 the list of potential backup jobs may be sorted based on at least one of criticality, file size, or historical backup performance. At block 808 the sorted list of backup jobs may be randomized while maintaining backup job ordering requirements. At block 810 resource requirements may be determined for each backup job, including memory usage, CPU utilization, and network bandwidth consumption. At block 812 a backup schedule may be created by matching backup jobs to available system resources. At block 814, the backup jobs may be executed according to the backup schedule, while dynamically adjusting the schedule based on real-time resource availability.

In some aspects, block 802 is configured to perform a depth-restricted find operation on a file system to identify directories for backup. This step corresponds to the depth-restricted directory search described in FIG. 3 (operation 302) and utilizes the file system structure illustrated in FIG. 5.

In some aspects, block 804 is configured to generate a list of potential backup jobs by analyzing the identified directories and determining a backup type for each directory. This step aligns with the job creation process outlined in FIG. 6 and builds upon the backup job pre-processor functionality described in FIG. 1 (backup job pre-processor 108) and FIG. 2 (backup job pre-processor 216A-C).

In some aspects, block 806 is configured to sort the list of potential backup jobs based on at least one of criticality, file size, or historical backup performance. This operation corresponds to the sorting process described in FIG. 3 (operation 304) and utilizes the techniques detailed in FIG. 6.

In some aspects, block 808 is configured to randomize the sorted list of backup jobs while maintaining backup job ordering requirements. This step aligns with the randomization process outlined in FIG. 3 (operation 310) and incorporates the techniques described in FIG. 7.

In some aspects, block 810 is configured to determine resource requirements for each backup job, including memory usage, CPU utilization, and network bandwidth consumption. This operation corresponds to the resource assessment techniques described in FIG. 7 and utilizes the system components outlined in FIG. 2.

In some aspects, block 812 is configured to create a backup schedule by matching backup jobs to available system resources. This step aligns with the job dispatching process described in FIG. 3 (operation 312) and FIG. 7, taking into account the system resources illustrated in FIG. 2.

In some aspects, block 814 is configured to execute the backup jobs according to the backup schedule, while dynamically adjusting the schedule based on real-time resource availability. This operation corresponds to the execution process outlined in FIG. 4 and incorporates the dynamic adjustment techniques described in FIG. 7.

Method 800 provides beneficial technical effects and acts as a technical solution to the technical problems introduced in the introduction to the detailed description in several ways. By implementing a depth-restricted find operation (block 802), method 800 addresses the challenge of inefficient traversal of deep directory structures, significantly reducing the time required for initial analysis of large file systems. The intelligent creation and sorting of backup jobs (blocks 804 and 806) optimize the backup process, leading to more balanced backup operations and improved overall system performance. The randomization of the sorted list (block 808) helps distribute the backup workload more evenly over time and across system resources, addressing the problem of inconsistent backup performance. By determining resource requirements and creating a resource-aware backup schedule (blocks 810 and 812), method 800 tackles the issue of poor resource utilization, ensuring efficient use of available system resources. The dynamic execution and adjustment of the backup schedule (block 814) addresses the challenge of adapting to varying file system characteristics and changing system resources, leading to more consistent and reliable backup performance. Throughout the process, method 800 enables the utilization of multiple network paths, as described in the dynamic job dispatching algorithm (FIG. 7), addressing the problem of network bottlenecks in backup operations.

By combining depth-restricted searches, intelligent job creation, resource-aware scheduling, and dynamic execution, method 800 addresses the technical problems of inefficient backups in large-scale computing environments. The method's ability to adapt to file system characteristics, balance workloads, and optimize resource usage provides tangible benefits in terms of reduced backup times, improved resource utilization, and enhanced overall backup performance. This comprehensive approach enables organizations to maintain robust data protection strategies even as their data volumes and complexity grow, without requiring proportional increases in backup infrastructure or time windows.

Note that FIG. 8 is just one example of a method, and other methods including fewer, additional, or alternative operations are possible consistent with this disclosure.

### Example Processing System for Performing Backup Operations

FIG. 9 depicts an example processing system 900 configured to perform various aspects described herein, including, for example, method 800 as described above with respect to FIG. 8 and other methods described herein.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output devices 904, one or more display devices 906, one or more network interfaces 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes a depth-restricted find operation module 914, a generate list module 916, a sort list module 918, a randomize sorted list module 920, a determine resource requirements module 922, a create backup schedule module 924, an execute backup jobs module 916, file system metadata 928, and file system data 930.

In certain embodiments, component 914 (depth-restricted find operation module) is configured to perform the depth-restricted find operation on a file system to identify directories for backup, as described in block 802 of FIG. 8. This module implements the depth-restricted directory search technique outlined in operation 302 of FIG. 3 and operates on the file system structure illustrated in FIG. 5.

In certain embodiments, component 916 (generate list module) is configured to generate a list of potential backup jobs by analyzing the identified directories and determining a backup type for each directory, as described in block 804 of FIG. 8. This module utilizes the job creation process outlined in FIG. 6 and builds upon the backup job pre-processor functionality described in backup job pre-processor 108 of FIG. 1 and backup job pre-processor 216A-C of FIG. 2.

In certain embodiments, component 918 (sort list module) is configured to sort the list of potential backup jobs based on criticality, file size, or historical backup performance, as described in block 806 of FIG. 8. This module implements the sorting process described in operation 304 of FIG. 3 and utilizes the techniques detailed in FIG. 6.

In certain embodiments, component 920 (randomize sorted list module) is configured to randomize the sorted list of backup jobs while maintaining backup job ordering requirements, as described in block 808 of FIG. 8. This module implements the randomization process outlined in operation 310 of FIG. 3 and incorporates the techniques described in FIG. 7.

In certain embodiments, component 922 (determine resource requirements module) is configured to determine resource requirements for each backup job, including memory usage, CPU utilization, and network bandwidth consumption, as described in block 810 of FIG. 8. This module utilizes the resource assessment techniques described in FIG. 7 and interacts with the system components outlined in FIG. 2.

In certain embodiments, component 924 (create backup schedule module) is configured to create a backup schedule by matching backup jobs to available system resources, as described in block 812 of FIG. 8. This module implements the job dispatching process described in operation 312 of FIG. 3 and FIG. 7, taking into account the system resources illustrated in FIG. 2.

In certain embodiments, component 926 (execute backup jobs module) is configured to execute the backup jobs according to the backup schedule, while dynamically adjusting the schedule based on real-time resource availability, as described in block 814 of FIG. 8. This module implements the execution process outlined in FIG. 4 and incorporates the dynamic adjustment techniques described in FIG. 7.

In certain embodiments, component 928 (file system metadata) is configured to store and manage metadata about the file system structure, as described in file system metadata 102 of FIG. 1. This module interacts with the depth-restricted find operation module 914 and the generate list module 916 to provide essential information for backup job creation and execution.

In certain embodiments, component 930 (file system data) is configured to represent the actual content of the files stored in the file system, as described in file system of FIG. 1. This module interacts with the execute backup jobs module 926 to ensure accurate and complete data backup.

Note that FIG. 9 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method for performing backup operations in a computing environment, comprising: performing a depth-restricted find operation on a file system to identify directories for backup; generating a list of potential backup jobs by analyzing the identified directories and determining a backup type for each directory; sorting the list of potential backup jobs based on at least one of criticality, file size, or historical backup performance; randomizing the sorted list of backup jobs while maintaining backup job ordering requirements; determining resource requirements for each backup job, including memory usage, CPU utilization, and network bandwidth consumption; creating a backup schedule by matching backup jobs to available system resources; and executing the backup jobs according to the backup schedule, while dynamically adjusting the backup schedule based on real-time resource availability.

Clause 2: A method according to Clause 1, wherein the depth-restricted find operation is dynamically adjusted based on characteristics of the file system including at least one of average directory depth, total file count, average files per directory, or file size distribution.

Clause 3: A method according to any one of Clauses 1-2, wherein generating the list of potential backup jobs comprises: analyzing each identified directory to determine whether to perform a local backup or a recursive backup; and creating separate backup jobs for subdirectories beyond the depth-restricted find operation.

Clause 4: A method according to Clause 3, wherein the determination between local and recursive backup is based on a decision tree that considers at least one of directory depth, file count, total data size, historical change rates, or directory structure.

Clause 5: A method according to any one of Clauses 1-4, wherein sorting the list of potential backup jobs comprises: calculating a priority score for each job based on a weighted combination of one or more of criticality, file size, or historical backup performance; and ordering the backup jobs in descending order of their priority scores.

Clause 6: A method according to Clause 5, further comprising dynamically adjusting weights used in the priority score calculation based on historical backup performance data.

Clause 7: A method according to any one of Clauses 1-6, wherein randomizing the sorted list of backup jobs comprises: dividing the sorted list into multiple tiers based on priority ranges; randomizing the order of backup jobs within each tier; and maintaining the order of tiers in the randomized list.

Clause 8: A method according to any one of Clauses 1-7, wherein determining resource requirements for each backup job comprises: analyzing historical resource usage data for similar backup jobs; estimating resource needs based on a current state of the file system; and creating a resource utilization profile for each job.

Clause 9: A method according to any one of Clauses 1-8, wherein creating the backup schedule comprises a constraint satisfaction algorithm to match backup jobs to available resources while maximizing overall backup efficiency.

Clause 10: A method according to Clause 9, further comprising applying user-defined scheduling policies as additional constraints in the constraint satisfaction algorithm.

Clause 11: A method according to any one of Clauses 1-10, wherein executing the backup jobs comprises: monitoring real-time system resource utilization; comparing actual resource usage to predicted resource requirements; and dynamically adjusting the backup schedule based on resource utilization.

Clause 12: A method according to Clause 11, further comprising: logging detailed performance metrics for each executed backup job; and using the logged metrics to refine future resource requirement predictions and scheduling decisions.

Clause 13: A method according to any one of Clauses 1-12, identifying directories containing specialized data types requiring unique backup handling procedures; applying predefined backup policies to the identified directories; and integrating specialized backup tasks into the backup schedule.

Clause 14: A method according to Clause 13, wherein the specialized data types includes at least one of: active databases, version-controlled repositories, virtual machine images, or containerized applications.

Clause 15: A processing system, comprising: a computing device that includes a memory for storing logic, the logic for causing the system to perform at least the following: performing a depth-restricted find operation on a file system to identify directories for backup; generating a list of potential backup jobs by analyzing the identified directories and determining a backup type for each directory; sorting the list of potential backup jobs based on at least one of criticality, file size, or historical backup performance; randomizing the sorted list of backup jobs while maintaining backup job ordering requirements; determining resource requirements for each backup job, including memory usage, CPU utilization, and network bandwidth consumption; creating a backup schedule by matching backup jobs to available system resources; and executing the backup jobs according to the backup schedule, while dynamically adjusting the backup schedule based on real-time resource availability.

Clause 16: A processing system according to Clause 15, wherein generating the list of potential backup jobs comprises analyzing each identified directory to determine whether to perform a local backup or a recursive backup and creating separate backup jobs for subdirectories beyond the depth-restricted find operation and wherein the determination between local and recursive backup is based on a decision tree that considers at least one of directory depth, file count, total data size, historical change rates, or directory structure.

Clause 17: A processing system according to any one of Clauses 15 or 16, wherein sorting the list of potential backup jobs comprises calculating a priority score for each potential backup job based on a weighted combination of one or more of criticality, file size, or historical backup performance and ordering the backup jobs in descending order of their priority scores and wherein the logic is further configured to cause the system to dynamically adjust weights used in the priority score calculation based on historical backup performance data.

Clause 18: A non-transitory computer-readable storage medium that includes logic that causes a computing device to perform at least the following: perform a depth-restricted find operation on a file system to identify directories for backup; generate a list of potential backup jobs by analyzing the identified directories and determining a backup type for each directory; sort the list of potential backup jobs based on at least one of criticality, file size, or historical backup performance; randomize the sorted list of backup jobs while maintaining backup job ordering requirements; determine resource requirements for each backup job, including memory usage, CPU utilization, and network bandwidth consumption; create a backup schedule by matching backup jobs to available system resources; and execute the backup jobs according to the backup schedule, while dynamically adjusting the backup schedule based on real-time resource availability.

Clause 19: A non-transitory computer-readable storage medium according to Clause 18, wherein generating the list of potential backup jobs comprises analyzing each identified directory to determine whether to perform a local backup or a recursive backup and creating separate backup jobs for subdirectories beyond the depth-restricted find operation and wherein the determination between local and recursive backup is based on a decision tree that considers at least one of directory depth, file count, total data size, historical change rates, or directory structure.

Clause 20: A non-transitory computer-readable storage medium according to any one of Clauses 18 or 19, wherein sorting the list of potential backup jobs comprises calculating a priority score for each potential backup job based on a weighted combination of one or more of criticality, file size, or historical backup performance and ordering the backup jobs in descending order of their priority scores and wherein the logic is further configured to cause the computing device to dynamically adjust weights used in the priority score calculation based on historical backup performance data.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for performing backup operations in a computing environment, comprising:
performing a depth-restricted find operation on a file system to identify directories for backup;
generating a list of potential backup jobs by analyzing the identified directories and determining a backup type for each directory;
sorting the list of potential backup jobs based on at least one of criticality, file size, or historical backup performance;
randomizing the sorted list of backup jobs while maintaining backup job ordering requirements;
determining resource requirements for each backup job, including memory usage, CPU utilization, and network bandwidth consumption;
creating a backup schedule by matching backup jobs to available system resources; and
executing the backup jobs according to the backup schedule, while dynamically adjusting the backup schedule based on real-time resource availability.

2. The method of claim 1, wherein the depth-restricted find operation is dynamically adjusted based on characteristics of the file system including at least one of average directory depth, total file count, average files per directory, or file size distribution.

3. The method of claim 1, wherein generating the list of potential backup jobs comprises:
analyzing each identified directory to determine whether to perform a local backup or a recursive backup; and
creating separate backup jobs for subdirectories beyond the depth-restricted find operation.

4. The method of claim 3, wherein the determination between local and recursive backup is based on a decision tree that considers at least one of directory depth, file count, total data size, historical change rates, or directory structure.

5. The method of claim 1, wherein sorting the list of potential backup jobs comprises:
calculating a priority score for each job based on a weighted combination of one or more of criticality, file size, or historical backup performance; and
ordering the backup jobs in descending order of their priority scores.

6. The method of claim 5, further comprising dynamically adjusting weights used in the priority score calculation based on historical backup performance data.

7. The method of claim 1, wherein randomizing the sorted list of backup jobs comprises:
dividing the sorted list into multiple tiers based on priority ranges;
randomizing the order of backup jobs within each tier; and
maintaining the order of tiers in the randomized list.

8. The method of claim 1, wherein determining resource requirements for each backup job comprises:
analyzing historical resource usage data for similar backup jobs;
estimating resource needs based on a current state of the file system; and
creating a resource utilization profile for each job.

9. The method of claim 1, wherein creating the backup schedule comprises a constraint satisfaction algorithm to match backup jobs to available resources while maximizing overall backup efficiency.

10. The method of claim 9, further comprising applying user-defined scheduling policies as additional constraints in the constraint satisfaction algorithm.

11. The method of claim 1, wherein executing the backup jobs comprises:
monitoring real-time system resource utilization;
comparing actual resource usage to predicted resource requirements; and
dynamically adjusting the backup schedule based on resource utilization.

12. The method of claim 11, further comprising:
logging detailed performance metrics for each executed backup job; and
using the logged metrics to refine future resource requirement predictions and scheduling decisions.

13. The method of claim 1, further comprising:
identifying directories containing specialized data types requiring unique backup handling procedures;
applying predefined backup policies to the identified directories; and
integrating specialized backup tasks into the backup schedule.

14. The method of claim 13, wherein the specialized data types includes at least one of: active databases, version-controlled repositories, virtual machine images, or containerized applications.

15. A system for performing backup operations comprising:
a computing device that includes a memory for storing logic, the logic for causing the system to perform at least the following:
performing a depth-restricted find operation on a file system to identify directories for backup;
generating a list of potential backup jobs by analyzing the identified directories and determining a backup type for each directory;
sorting the list of potential backup jobs based on at least one of criticality, file size, or historical backup performance;
randomizing the sorted list of backup jobs while maintaining backup job ordering requirements;
determining resource requirements for each backup job, including memory usage, CPU utilization, and network bandwidth consumption;
creating a backup schedule by matching backup jobs to available system resources; and
executing the backup jobs according to the backup schedule, while dynamically adjusting the backup schedule based on real-time resource availability.

16. The system of claim 15, wherein generating the list of potential backup jobs comprises analyzing each identified directory to determine whether to perform a local backup or a recursive backup and creating separate backup jobs for subdirectories beyond the depth-restricted find operation and wherein the determination between local and recursive backup is based on a decision tree that considers at least one of directory depth, file count, total data size, historical change rates, or directory structure.

17. The system of claim 15, wherein sorting the list of potential backup jobs comprises calculating a priority score for each potential backup job based on a weighted combination of one or more of criticality, file size, or historical backup performance and ordering the backup jobs in descending order of their priority scores and wherein the logic is further configured to cause the system to dynamically adjust weights used in the priority score calculation based on historical backup performance data.

18. A non-transitory computer-readable storage medium that includes logic that causes a computing device to perform at least the following:
perform a depth-restricted find operation on a file system to identify directories for backup;
generate a list of potential backup jobs by analyzing the identified directories and determining a backup type for each directory;
sort the list of potential backup jobs based on at least one of criticality, file size, or historical backup performance;
randomize the sorted list of backup jobs while maintaining backup job ordering requirements;
determine resource requirements for each backup job, including memory usage, CPU utilization, and network bandwidth consumption;
create a backup schedule by matching backup jobs to available system resources; and
execute the backup jobs according to the backup schedule, while dynamically adjusting the backup schedule based on real-time resource availability.

19. The non-transitory computer-readable storage medium of claim 18, wherein generating the list of potential backup jobs comprises analyzing each identified directory to determine whether to perform a local backup or a recursive backup and creating separate backup jobs for subdirectories beyond the depth-restricted find operation and wherein the determination between local and recursive backup is based on a decision tree that considers at least one of directory depth, file count, total data size, historical change rates, or directory structure.

20. The non-transitory computer-readable storage medium of claim 18, wherein sorting the list of potential backup jobs comprises calculating a priority score for each potential backup job based on a weighted combination of one or more of criticality, file size, or historical backup performance and ordering the backup jobs in descending order of their priority scores and wherein the logic is further configured to cause the computing device to dynamically adjust weights used in the priority score calculation based on historical backup performance data.
